(19) United States
(12) Patent Application Publication
(10) Pub. No.: US 2010/0325928 A1
(43) Pub. Date: Dec. 30, 2010

(54) CONTAINER LABELS

(76) Inventors: Tom Moulton, San Francisco, CA (US); Jim Happ, Glen Ellen, CA (US); Linda Newman, Santa Rosa, CA (US); Venus Happ, Sonoma, CA (US)

Correspondence Address: BUTZEL LONG;IP DOCKETING DEPT, 350 SOUTH MAIN STREET, SUITE 300, ANN ARBOR, MI, 48104, US

(21) Appl. No.: 12/492,733

(22) Filed: Jun. 26, 2009

(51) Int. Cl. G09F 3/10; G09F 3/00

(52) U.S. Cl. 40/638; 40/299.01

(57) ABSTRACT

Improved labels are disclosed for containers of the type defined at least in part by at least one sidewall having an outer surface. The outer surface has at least one label thereon, the label comprising a first writing surface defined by a plurality of individual writing areas arranged in an array characterized in that adjacent writing areas are at least substantially isolated from each other by an intermediate space, and a second writing surface in the intermediate space. The second writing surface is vertically recessed relative to the first writing surface.

### FIELD OF THE INVENTION

The present invention relates generally to labels for providing handwritten identifying information and other indicia on containers, including, without limitation, laboratory containers such as test-tubes, centrifuge tubes, culture tubes, etc.

### BACKGROUND

Various types of containers, including tubes, boxes, bags, jars, etc., are commonplace for holding a wide variety of items. In many circumstances, such as, for example, the laboratory environment, in the kitchen environment, etc., it may be desirable to provide information directly on the container. Conventionally, this may be accomplished by writing directly on a surface of the container using a suitable writing implement, such as a pen, marker, etc. This is generally unsatisfactory as the writing can smear or rapidly become illegible due to handling, etc. This is especially true in the case of containers handled in the laboratory environment.

Alternatively, it is known to provide dedicated labels for containers. For example, a container such as a laboratory test-tube, centrifuge tube, etc. may contain a label providing a writing surface for a user to apply thereon information concerning a sample or other item contained in the tube. Such labels may be in the form of removable adhesive labels that are user-applied to the container, or they may take the form of a labeling area pre-defined, for instance by printing, directly on the container. For example, it is known that laboratory tubes may be printed or etched with a uniform permanent writing surface—commonly referred to as a “labeling spot”—of a different material and color (commonly, white) than that of the tube itself. Even these solutions are imperfect, however. With respect to labeling spots, it is the case that the material from which these writing surfaces are printed tends to retard the drying time for ink handwriting applied thereto. This, in turn, increases the likelihood that the handwriting thereon will be smeared during subsequent handling of the container.

There is, accordingly, a need for containers with improved labels that overcome the drawbacks attending the prior art.

### SUMMARY

The specification discloses improved container labels for containers of the type defined at least in part by at least one sidewall having an outer surface. At least one such label is provided on such sidewall outer surface, the label comprising a first writing surface defined by a plurality of individual writing areas arranged in an array characterized in that adjacent writing areas are at least substantially isolated from each other by an intermediate space, and a second writing surface in the intermediate space. The second writing surface is vertically recessed relative to the first writing surface.

According to one feature of the invention, the first and second writing surfaces are formed integrally with the at least one sidewall of the container. This may, in one embodiment of the invention, be accomplished by etching the first and second writing surfaces into the outer surface of the at least one sidewall of the container.

According to another embodiment, the plurality of individual writing areas of the first writing surface are applied to the outer surface of the at least one sidewall of the container so that each of said plurality of writing areas is vertically raised relative to the outer surface of the at least one sidewall, while the second writing surface is defined on the outer surface of the at least one sidewall in the intermediate space between the individual writing areas. This may be accomplished, for instance, by printing the plurality of individual writing areas of the first writing surface onto the outer surface of the at least one sidewall of the container. Alternatively, the plurality of individual writing areas of the first writing surface may comprise adhesive labels applied to the outer surface of the at least one sidewall of the container.

Per another feature of the invention, the total area of the second writing surface is no larger than the total area of the first writing surface for at least a majority of the area of the label.

In one embodiment of the invention, the array of first writing areas is characterized in that adjacent writing areas are completely isolated from each other. Per this embodiment, the second writing surface comprises a contiguous writing surface.

In still another embodiment hereof, the first and second writing surfaces are defined on a separate adhesive label that is applied to the outer surface of the at least one sidewall of the container. This adhesive label may, per one embodiment thereof, comprise a writing surface and an opposite adhesive surface. The writing surface includes a plurality of discrete writing areas that are each vertically raised from the writing surface, the plurality of discrete writing areas being arranged in an array characterized in that adjacent writing areas are separated from each other by an intermediate space defining an intermediate writing area. The plurality of discrete writing areas may be embossed on the writing surface. Alternatively, the plurality of discrete writing areas may be printed on the writing surface.

### BRIEF DESCRIPTION OF THE DRAWINGS

For a better understanding of the present invention, and to show more clearly how it may be carried into effect, reference will now be made, by way of example, to the accompanying drawings, which show exemplary embodiments of the present invention and in which:

FIG. 1 is a perspective view of an exemplary embodiment of the inventive container label;

FIG. 2 is a detailed cross-sectional view through a container sidewall showing the inventive container label;

FIG. 3 is detailed perspective view of the exemplary embodiment of FIG. 1, further showing the application of handwriting information on the inventive label;

FIG. 4 is detailed perspective view of an alternative embodiment of the inventive container label, according to which the first writing surface is comprised of adhesive labels applied to the container surface;

FIG. 5 is a detailed perspective view of an alternative embodiment of the inventive container label, according to which the second writing surface is formed in the sidewall of a container;

FIG. 6 is a detailed perspective view of a further alternative embodiment of the inventive container label, according to which the second writing surface is formed in the sidewall of a container after the first writing surface is applied on to the surface of the container sidewall;

FIG. 7 is a perspective view of a further embodiment of the invention, according to which the label is a separate adhesive label that may be applied to the outside surface of a container; and

FIG. 8 is a perspective view of an alternate embodiment of the invention as shown in FIG. 7.

### WRITTEN DESCRIPTION

As required, detailed embodiments of the present invention are disclosed herein. However, it is to be understood that the disclosed embodiments are merely exemplary of the invention that may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

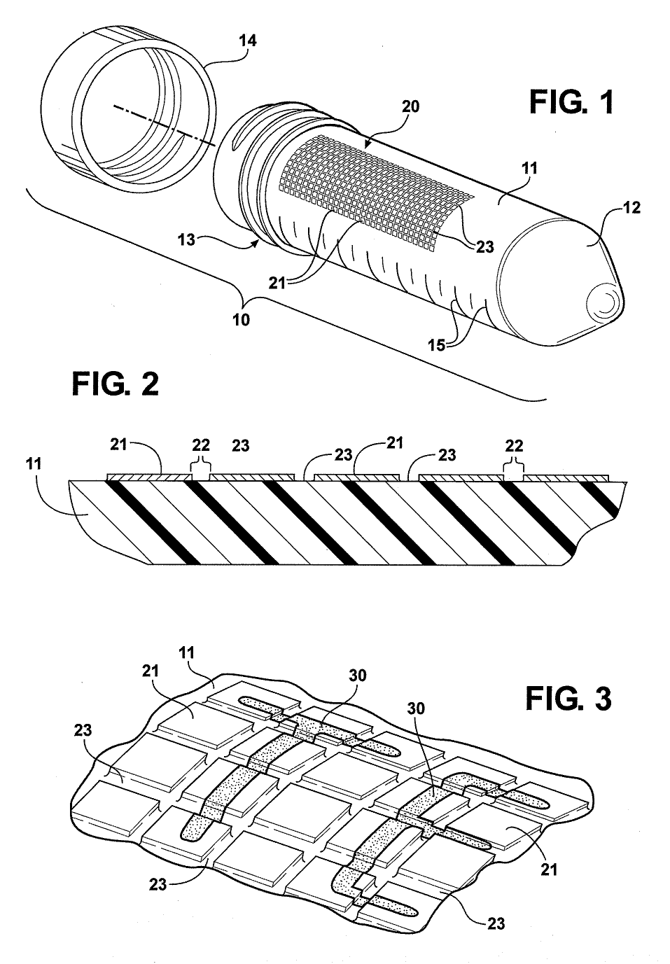

Referring now to the drawings, wherein like numerals refer to like or corresponding parts throughout the several views, the present invention is generally characterized as a container 10 defined at least in part by at least one sidewall 11 with an outer surface, the outer surface having at least one label 20 comprising a first writing surface defined by a plurality of individual writing areas 21 arranged in an array characterized in that adjacent writing areas are at least substantially isolated from each other by an intermediate space 22, and a second writing surface 23 in the intermediate space, the second writing surface 23 being vertically recessed relative to the first writing surface (FIGS. 1-3).

As described further below, label 20 may be removably attached to and/or formed integrally with the container 10.

Referring specifically to the embodiment of FIGS. 1-3, container 10 is exemplified as a tube, such as a centrifuge tube, culture tube, test tube, or the like, of generally cylindrical construction defined at least in substantial part by sidewall 11, and including a frustoconically-shaped end portion 12. The opposite end is, per convention, threaded (as shown at 13) to receive thereon a cap 14 for selectively closing the container 10. But while such a container is shown and described as being exemplary of an embodiment of the present invention, it should be understood that the present invention may be embodied in, or employed in connection with, any of a myriad variety of conventional containers unlimited by their overall shape or the type of material which they may be designed to hold. Thus, by way of non-limiting example, the present invention may be embodied in containers having curved or flat sidewalls, in containers having multiple sidewalls defining quadrilateral or triangular shapes, or in containers, such as test tube racks or the like, for holding other containers, etc.

The container, such as shown at 10, may be fabricated from one or more of a variety of conventional materials, including, without limitation, glass, metal, plastic, etc. For the particular tube 10 of the exemplary embodiment of FIGS. 1-3, suitable materials include medical grade or other resin (which may, optionally, be an optically clear resin), polypropylene, polystyrene, or the like.

As will be appreciated by those skilled in the art, the container incorporating the present invention may, depending on its particular utility, include additional conventional features such as, by way of non-limiting example, an interior coating to facilitate storage of items therein, indicia such as graduation markings 15 used for measuring, an interior wall, etc. It will be understood that such additional features may be selected according to user preference or desire, and that they comprise no part of the present invention.

One or more components of the container 10, including sidewall 11 and cap 14 (if the container includes a cap), may be clear or opaque, colored or transparent, or any combination thereof.

With continuing reference to FIGS. 1-3, the one or more labels each comprise, as noted, a first writing surface defined by a plurality of individual writing areas 21 which are at least substantially isolated from each other by an intermediate space 22, with a second writing surface 23 defined in this intermediate space. As shown, the second writing surface 23 is vertically recessed relative to the individual writing areas 21 of the first writing surface. More specifically according to the embodiment of FIGS. 1-3, the second writing surface 23 is essentially defined on the outside surface of the container sidewall 11 in the intermediate space 22.

The shape of each individual writing area 21 is non-limiting, i.e. square shaped, circular, triangular, etc., and may be selected according to aesthetic considerations. In the illustrated embodiment, each individual writing area 21 is square in shape in plan view.

As shown in the illustrated embodiments, the individual writing areas 21 are spaced apart so as to be discrete with respect to each other, as shown. However, it is contemplated that two or more of the individual writing areas may be partially interconnected.

The plurality of individual writing areas 21 of the first writing surface are arranged in an array, or regular pattern. For instance, the illustrated embodiments show an array comprised of multiple rows each including a plurality of individual writing areas 21 ordered in generally linear fashion to define, overall, a label that is rectangular in shape. Of course, it will be appreciated with the benefit of this disclosure that the manner in which the individual writing areas 21 are so ordered may be varied, subject only to the provision of a label of desired overall shape and dimensions. Correspondingly, it will be appreciated that the overall shape of the label is not limited to the rectangular shape of the exemplary embodiment, but may instead take any desired form according to user preference.

Within the foregoing array, the relative spacing of the individual writing areas 21 and the second writing surface 23 in the intermediate space 22 is such that, for at least the majority of the area of the label 10 (that is, the area defined collectively by the first and second writing surfaces), the total area of the second writing surface 23 is approximately no larger than the total area of the first writing surface—that is, the total area defined by the plurality of individual writing areas 21. It has been particularly found that an area of the second writing surface 23 relative to the area defined by the plurality of individual writing areas 21 that facilitates the deposition of between approximately 20% to approximately 50%, and preferably between approximately 40% to approximately 50%, of writeable medium (e.g., ink from the writing instrument used to mark the label 10) below the area defined by the plurality of individual writing areas 21 improves the legibility over time of the handwriting applied to the label 10 by reducing smearing of the writeable medium disposed vertically below the first writing surface.

As particularly shown in the illustrated embodiments, the relative spacing is such that the second writing surface 23 defines a plurality of relatively thin, contiguous lines in comparison to the isolated individual writing areas 21 of the first writing surface.

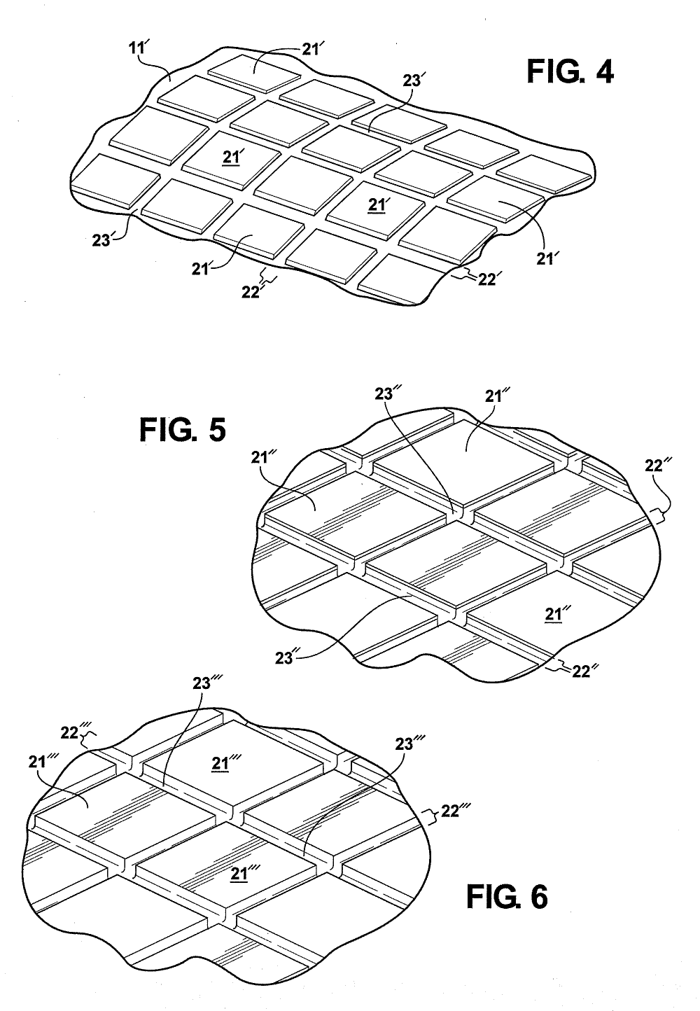

As noted, the second writing surface 23 is vertically recessed relative to the individual writing areas 21 of the first writing surface. This may be accomplished by, for instance, applying the individual writing areas 21 to the outer surface of sidewall 11 so that each is vertically raised relative to the outer surface of sidewall 11, whereby the second writing surface 23 is defined on the outer surface of the sidewall in the intermediate space 22 between the individual writing areas 21. For example, the plurality of individual writing areas 21 may, as in the illustrated embodiment of FIGS. 1-3, be printed on the outer surface of container sidewall 11, further to which each such printed writing area 21 will thus have a thickness so that the second writing area 23 is defined at the outer surface of the sidewall 11 in the intermediate space 22 between the individual writing areas 21. Alternatively, the plurality of individual writing areas 21 may take the form of multiple adhesive elements 21′ applied in an array to the outer surface of the container sidewall 11′, as shown in FIG. 4. As with the printing of the individual writing areas 21, each such adhesive writing area 21′ has a predetermined thickness so that the second writing area 23′ is defined at the outer surface of the sidewall 11′ in the intermediate space 22′ between the individual writing areas 21′. Per this embodiment of the invention, the material from which the adhesive individual writing areas are formed may be any known in the art, including, by way of non-limiting example, an adhesive-backed nylon material such as is employed in conventional adhesive labels.

In either of the foregoing embodiments, it is further contemplated that, to the extent a greater vertical difference between the first and second writing surfaces is required, the second writing surface 23 may be formed in, rather than on, the outer surface of the container sidewall 11. This may be accomplished, for example, by etching, as shown in FIG. 5, according to which the intermediate spaces 22″ are further defined by etching into the surface of the container sidewall after the individual writing areas 21″ have been applied thereto, for instance by printing. By virtue of the foregoing, it will be appreciated that the second writing surface 23″ is disposed below the outside surface of the sidewall.

While the labels of the present invention may be manufactured according to a variety of conventional means, including as hereafter described, it is presently the case that labels formed by applying the plurality of individual writing areas to the outside surface of the container by printing are manufactured using a dry-offset printing process using a machine for that purpose produced by Apex Machine Company (Ft. Lauderdale, Fla.). According to the dry-offset process, a printing plate with a correct, raised image of the image to be printed is supplied with a quantity of paste ink. The ink image is transferred from the printing plate to a smooth piece of elastomeric material referred to as a blanket. The ink image is then transferred from the blanket to the container to be printed.

Where the individual writing area 21 of the first writing surface are printed on the container, the material of the first writing areas may be any known in the art, including, by way of non-limiting example, acrylic or olefin-based inks.

According to another embodiment of the invention, the first and second writing surfaces may both be formed integrally with the container sidewall 11. This may be accomplished by conventional means such as, by way of non-limiting example, etching, surface ablation, etc. Further to this embodiment, shown in FIG. 6, it is contemplated that the plurality of individual writing areas 21′″ may be defined in an array on the outer surface of the container sidewall by surface ablation, etching, or the like to define a surface for receiving ink or other handwriting medium. In the intermediate space 22′″ between these individual writing areas 21′″, second writing surface 23′″ is etched or otherwise formed in the outer surface so as to be vertically recessed relative to the outer surface and, thus, the individual writing areas 21′″ of the first writing surface. It is also contemplated, per this embodiment of the invention, that the first writing surface may alternatively comprise the unaltered outer surface of the container sidewall, the array of such individual writing areas 21′″ thereof simply being defined by the intermediate space 23′″ comprising the second writing surface 23′″ formed into the outer surface of the container sidewall, such as by etching, etc.

According to any of the aforedescribed embodiments, the label of the present invention may be defined in one or more colors, as desired. Thus, by way of non-limiting example, the individual writing areas of the first writing surface may be white and the second writing surface may take the color of the container sidewall material—which may, for instance, be white or some other color, or even transparent.

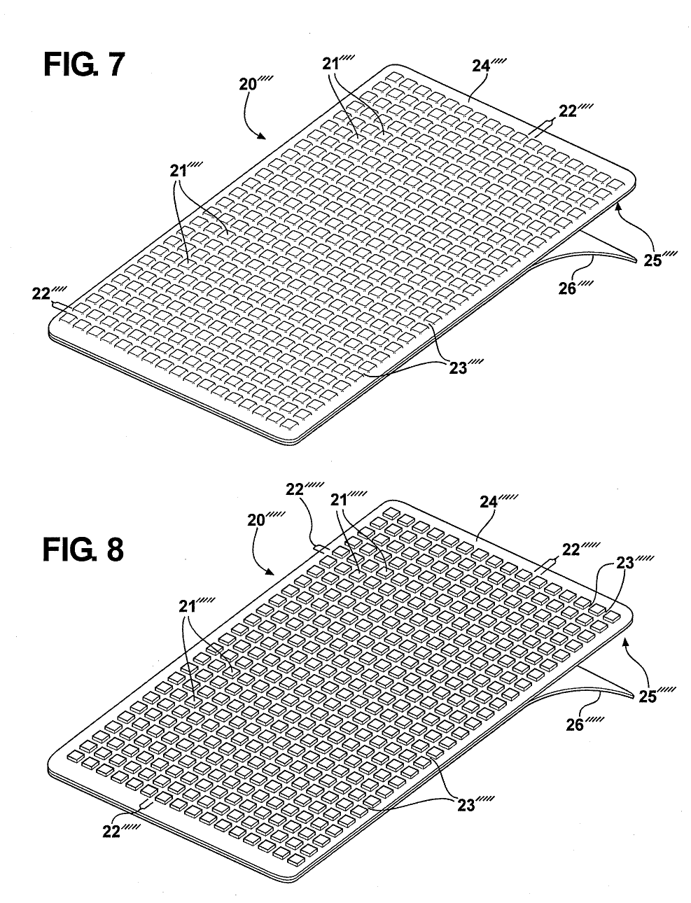

According to still another embodiment, shown in FIGS. 7 and 8, the label may take the form of a separate adhesive label 20″″ comprising a writing surface 24″″ and an opposite adhesive surface 25″″ which may, per convention, be protected by a releasable layer 26″″ (FIG. 7). The plurality of discrete writing areas 21″″ comprising the first writing surface are each vertically raised from the writing surface 24″″ and arranged in an array characterized in that adjacent writing areas are separated from each other by an intermediate space 22″″ defining a vertically lower, intermediate writing area 23″″ corresponding to the second writing area of the aforedescribed embodiments. Per this embodiment, the material from which the label 20″″ is formed may be any known in the art, including, by way of non-limiting example, an adhesive-backed nylon material such as is employed in conventional adhesive labels.

It is contemplated that where the inventive labels are formed as separate adhesive labels such as described above, the plurality of discrete, vertically raised writing areas 21″″ will be formed by embossing, such as depicted in the exemplary embodiment of FIG. 7, or, in the alternative, by printing the vertically raised writing areas 21′″″ onto the writing surface 24′″″ of the label 20′″″, such as, for instance, by using the dry-offset printing method heretofore described, as shown in the embodiment of FIG. 8.

Referring again to FIG. 3, in operation of the invention, a user writes information on the label using a writing instrument (not shown), such as a pen, marker, etc. The writeable medium 30 from the writing instrument adheres to both the first 21 and second 23 writing surfaces. For an ink-type writeable medium, the ink may dry faster on the second writing surface 23 than on the individual writing areas 21 of the first writing surface, thereby decreasing the likelihood of smearing the writeable medium during subsequent handling of the container. Furthermore, the writeable medium may, in the vertically lower second writing surface 23, be better protected from smearing by reason of the surrounding, vertically higher individual writing areas 21 of the first writing surface.

The foregoing description of the exemplary embodiments of the invention have been presented for purposes of illustration and description. They are not intended to be exhaustive of, or to limit, the invention to the precise forms disclosed, and modifications and variations are possible in light of the above teachings or may be acquired from practice of the innovation. The embodiments shown and described in order to explain the principals of the innovation and its practical application to enable one skilled in the art to utilize the innovation in various embodiments and with various modifications as are suited to the particular use contemplated. Accordingly, all such modifications and embodiments are intended to be included within the scope of the present invention. Other substitutions, modifications, changes and omissions may be made in the design, operating conditions and arrangement of the exemplary embodiments without departing from the spirit of the present invention.

The invention in which an exclusive property or privilege is claimed is defined as follows:

1. A container defined at least in part by at least one sidewall having an outer surface, the outer surface having at least one label comprising a first writing surface defined by a plurality of individual writing areas arranged in an array characterized in that adjacent writing areas are at least substantially isolated from each other by an intermediate space, and a second writing surface in the intermediate space, the second writing surface being vertically recessed relative to the first writing surface.

2. The container of claim 1, wherein the first and second writing surfaces are formed integrally with the at least one sidewall of the container.

3. The container of claim 2, wherein the plurality of first and second writing surfaces are etched into the outer surface of the at least one sidewall of the container.

4. The container of claim 1, wherein the plurality of individual writing areas of the first writing surface are applied to the outer surface of the at least one sidewall of the container so that each of said plurality of writing areas is vertically raised relative to the outer surface of the at least one sidewall, and wherein further the second writing surface is defined on the outer surface of the at least one sidewall in the intermediate space between the individual writing areas.

5. The container of claim 4, wherein the plurality of individual writing areas of the first writing surface are printed on the outer surface of the at least one sidewall of the container.

6. The container of claim 4, wherein the plurality of individual writing areas of the first writing surface are adhesive labels applied on the outer surface of the at least one sidewall of the container.

7. The container of claim 1, wherein, for at least the majority of the area of the label, the total area of the second writing surface is no larger than the total area of the first writing surface.

8. The container of claim 1, wherein the array is characterized in that adjacent writing areas of the first writing surface are completely isolated from each other, and whereby the second writing surface comprises a contiguous writing surface.

9. The container of claim 1, wherein the first and second writing surfaces are defined on a separate adhesive label that is applied to the outer surface of the at least one sidewall of the container.

10. A container defined at least in part by at least one sidewall having an outer surface, the outer surface having at least one label comprising a first writing surface defined by a plurality of individual writing areas arranged in an array characterized in that adjacent writing areas are at least substantially isolated from each other by an intermediate space, and a second writing surface in the intermediate space, the second writing surface being vertically recessed relative to the first writing surface; and
wherein the plurality of individual writing areas of the first writing surface are applied to the outer surface of the at least one sidewall of the container so that each of said plurality of writing areas is vertically raised relative to the outer surface of the at least one sidewall, and wherein further the second writing surface is defined on the outer surface of the at least one sidewall in the intermediate space between the individual writing areas.

11. The container of claim 10, wherein the plurality of individual writing areas of the first writing surface are printed on the outer surface of the at least one sidewall of the container.

12. The container of claim 10, wherein the plurality of individual writing areas of the first writing surface are adhesive labels applied onto the outer surface of the at least one sidewall of the container.

13. The container of claim 10, wherein, for at least the majority of the area of the label, the total area of the second writing surface is no larger than the total area of the first writing surface.

14. The container of claim 10, wherein the array is characterized in that adjacent writing areas of the first writing surface are completely isolated from each other, and whereby the second writing surface comprises a contiguous writing surface.

15. A container defined at least in part by at least one sidewall having an outer surface, the outer surface having at least one label comprising a first writing surface defined by a plurality of individual writing areas arranged in an array characterized in that adjacent writing areas are completely isolated from each other by an intermediate space, and a second writing surface in the intermediate space, the second writing surface being vertically recessed relative to the first writing surface; and
wherein the plurality of individual writing areas of the first writing surface are printed on the outer surface of the at least one sidewall of the container so that each of said plurality of writing areas is vertically raised relative to the outer surface of the at least one sidewall, and wherein further the second writing surface is defined on the outer surface of the at least one sidewall in the intermediate space between the individual writing areas.

16. The container of claim 15, wherein, for at least the majority of the area of the label, the total area of the second writing surface is no larger than the total area of the first writing surface.

17. An adhesive label comprising a writing surface and an opposite adhesive surface, the writing surface including a plurality of discrete writing areas that are each vertically raised from the writing surface, the plurality of discrete writing areas being arranged in an array characterized in that adjacent writing areas are separated from each other by an intermediate space defining an intermediate writing area.

18. The container of claim 17, wherein, for at least the majority of the area of the label, the total area of the intermediate writing area is no greater than the total area of the plurality of discrete writing areas.

19. The container of claim 17, wherein the plurality of discrete writing areas are embossed on the writing surface.

20. The container of claim 17, wherein the plurality of discrete writing areas are printed on the writing surface.
